(19) United States
(12) Patent Application Publication
(10) Pub. No.: US 2026/0014510 A1
(43) Pub. Date: Jan. 15, 2026

(54) SCRUBBING APPARATUS

(71) Applicant: Seung Hwan OH, Seoul (KR)

(72) Inventor: Seung Hwan OH, Seoul (KR)

(21) Appl. No.: 19/204,702

(22) Filed: May 12, 2025

Related U.S. Application Data
(63) Continuation of application No. PCT/KR2024/011939, filed on Aug. 12, 2024.

(30) Foreign Application Priority Data
Jul. 10, 2024 (KR) 10-2024-0090911

(51) Int. Cl. B01D 47/02; B01D 47/06

(52) U.S. Cl. CPC B01D 47/028; B01D 47/06

(57) ABSTRACT

The scrubbing apparatus may comprises a scrubbing chamber defining a scrubbing space, a separating wall dividing the scrubbing space into a first sub-space and a second sub-space, a spray nozzle in the first sub-space to spray a first cleaning solution into the first sub-space, a first scrubbing plate fixed to the separating wall, a cleaning solution supply nozzle supplying a second cleaning solution onto an upper surface of the first scrubbing plate, a cleaning solution storage tank, and a plurality of first scrubbing holes penetrating the first scrubbing plate, wherein a portion of impurities contained in the gas is dissolved into the first cleaning solution in the first sub-space, and another portion of impurities contained in the gas is dissolved into the second cleaning solution on the upper surface of the first scrubbing plate after the gas ascends through the plurality of first scrubbing holes in the second subspace.

### TECHNICAL FIELD

The present invention relates to a scrubbing apparatus. Specifically, the present invention relates to the scrubbing apparatus that improves scrubbing efficiency by increasing a contact area between a cleaning solution and a gas.

### BACKGROUND ART

Many kinds of air pollutants are generated in modern industries. In particular, various chemicals are used in the process of manufacturing semiconductor devices. Many of these have very low human permissible concentrations. Therefore, it is very important to remove and discharge air pollutants from the gas emitted in the semiconductor industry.

Currently used air pollution prevention facilities include dust collectors and scrubbers, and they are installed considering their efficiency depending on the type of pollutant. Among these, scrubbers are widely used because they can simultaneously process dust, exhaust gas, and high-temperature gas.

Specifically, scrubbers are classified into dry, wet, and plasma types depending on the method of treating the exhaust gas, and wet scrubbers are used in a process that causes the exhaust gas to come into contact with a liquid to dissolve water-soluble components in the gas into the liquid.

In wet scrubbers, a cleaning solution is generally used to effectively remove harmful components of the exhaust gas. When the cleaning solution comes into contact with harmful components, it removes the harmful components through a chemical reaction such as neutralization, so the one that best reacts chemically with the harmful components of the emitted gas should be selected. The performance of the wet scrubber is determined by whether the solution containing the cleaning solution can efficiently contact the exhaust gas. Therefore, in the past, a filler was installed so that the solution containing the cleaning solution, and the exhaust gas could sufficiently come into contact, and a spray nozzle was installed to supply water with small particles.

Recently, a technology that can improve the contact area between the scrubbing solution containing the cleaning solution and the exhaust gas has been studied.

### SUMMARY

### Technical Problem

The technical problem that the present invention is trying to solve is to provide a scrubbing apparatus that improves the scrubbing efficiency by improving the contact area between the cleaning solution and the gas.

The problems that the present invention is trying to solve are not limited to the problems mentioned above, and other problems that are not mentioned can be clearly understood by those skilled in the art from the description below.

### Solution to Problem

A scrubbing apparatus according to some embodiments of the present invention for achieving the above technical problem comprises a scrubbing chamber defining a scrubbing space for scrubbing impurities contained in a gas, a separating wall dividing the scrubbing space into a first sub-space and a second sub-space, a spray nozzle disposed in the first sub-space, and spraying a first cleaning solution into the first sub-space, a scrubbing plate disposed in the second sub-space, and fixed to the separating wall, a cleaning solution supply nozzle disposed in an upper part of the second sub-space, and supplying a second cleaning solution to an upper surface of the first scrubbing plate, a cleaning solution storage tank installed in a lower part of the scrubbing chamber, and storing the first cleaning solution with the impurities dissolved therein and the second solution with the impurities therein, and a plurality of first scrubbing hole penetrating the first scrubbing plate, wherein a portion of the impurities contained in the gas is dissolved in the first cleaning solution in the first sub-space, and wherein another portion of the impurities contained in the gas is dissolved in the second cleaning solution on the upper surface of the first scrubbing plate after the gas ascends through the plurality of first scrubbing holes in the second sub-space.

In some embodiments, wherein the dissolving another portion of the impurities contained in the gas into the second cleaning solution comprises the forming bubbles within the second cleaning solution on the upper surface of the first scrubbing plate as the gas ascends through the plurality of first scrubbing holes and dissolving the impurities at the contact area between the bubbles and the second cleaning solution.

As bubbles are generated in the second cleaning solution, the contact area between the gas and the second cleaning solution may be increased. Accordingly, the efficiency of the scrubbing process may be improved.

In some embodiments, wherein a first impurity dissolved in the first cleaning solution in the first sub-space and a second impurity dissolved in the second cleaning solution in the second sub-space are different from each other, and wherein the first cleaning solution is different from the second cleaning solution.

In some embodiments, wherein the first cleaning solution is viscosity, and the second cleaning solution is non-viscous. Therefore, the first impurity may be well dissolved in the first cleaning solution, and the second impurity may be well dissolved in the second cleaning solution.

In some embodiment, wherein a particle size of the first impurity dissolved in the first cleaning solution is different from a particle size of the second impurity dissolved in the second cleaning solution.

The scrubbing apparatus according to some embodiments further comprises a second scrubbing plate disposed in the second sub-space, fixed to the separating wall, and disposed on a lower surface opposing the upper surface of the first scrubbing plate, and a plurality of second scrubbing holes penetrating the second scrubbing plate, wherein the first scrubbing plate and the second scrubbing plate are arranged in a zigzag configuration.

In some embodiments, wherein the second cleaning solution flows in a first direction along the upper surface of the first scrubbing plate and is discharged onto an upper surface of the second scrubbing plate, wherein the second cleaning solution flows in a negative first direction along the upper surface of the second scrubbing plate, and wherein the lower surface of the first scrubbing plate and the upper surface of the second scrubbing plate face each other.

The scrubbing apparatus according to some embodiments further comprises a third scrubbing plate disposed in the second sub-space, fixed to the separating wall, and disposed on a lower surface opposing the upper surface of the second scrubbing plate, and a plurality of third scrubbing holes penetrating the third scrubbing plate, wherein the second scrubbing plate and the third scrubbing plate are arranged in a zigzag configuration, and wherein the first scrubbing plate and the third scrubbing plate overlap each other in a vertical direction.

The scrubbing apparatus according to some embodiments further comprises a second scrubbing plate disposed in the second sub-space, and disposed on a lower surface opposing the upper surface of the first scrubbing plate, and a plurality of second scrubbing holes penetrating the second scrubbing plate, wherein a shape of the first scrubbing plate is different from a shape of the second scrubbing plate, wherein the first scrubbing plate includes an opening exposing at least a portion of the upper surface of the second scrubbing plate, and wherein the second scrubbing plate extends in the third direction and is spaced apart from the separating wall.

In some embodiments, wherein the second cleaning solution flows along the upper surface of the first scrubbing plate toward the opening and is discharged onto the upper surface of the second scrubbing plate, wherein the second cleaning solution flows along the upper surface of the second scrubbing plate in a direction opposite to the opening, and wherein the lower surface of the first scrubbing plate and the upper surface of the second scrubbing plate face each other.

In some embodiments, wherein the separating wall has at least one of a bar shape, an L-shape, or a U-shape in a planar view.

In some embodiments, wherein the cleaning solution storage tank includes a first tank and a second tank that are separated from each other, wherein the first tank stores the first cleaning solution with the impurities dissolved therein, and wherein the second tank stores the second cleaning solution with the impurities dissolved therein.

In some embodiments, wherein the spray nozzle sprays the first cleaning solution in a first direction, and wherein the first direction is parallel to an extension direction of the first scrubbing plate.

In some embodiments, wherein the spray nozzle sprays the first cleaning solution in a first direction, and wherein the first direction intersects with both an extension direction of the first scrubbing plate and an extension direction of the separating wall.

Specific details of other embodiments are included in the specification and drawings.

### Effect of Invention

The scrubbing apparatus of the present invention includes at least one scrubbing plate. Scrubbing holes penetrating the scrubbing plate are formed in the scrubbing plate. As the gas ascends through the scrubbing holes, bubbles may be formed within the cleaning solution flowing on an upper surface of the scrubbing plate.

As the bubbles are formed, the contact area between the cleaning solution and the gas increases. Due to the increased contact area, hydrophilic impurities in the gas may be dissolved more effectively in the cleaning solution. Accordingly, the gas from which impurities(contaminants) have been removed may be discharged to the outside of the scrubbing apparatus.

### BRIEF DESCRIPTION OF DRAWINGS

FIG. 1 is a drawing briefly explaining a scrubbing system including a scrubbing apparatus to some embodiments of the present invention.

FIG. 2 is an exemplary perspective view for explaining the scrubbing apparatus of FIG. 1.

FIG. 3 is an exemplary cross-sectional view for explaining the scrubbing apparatus of FIG. 1.

FIG. 4 is an enlarged view of the P area of FIG. 3.

FIG. 5 is an exemplary plan view for explaining the scrubbing apparatus of FIG. 1.

FIGS. 6, 7, 8, 9, 10, 11, 12 and 13 are drawings for explaining the scrubbing apparatus according to some other embodiments of the present invention, respectively.

FIGS. 14 and 15 are drawings for explaining an operating method of a scrubbing apparatus according to some embodiments of the present invention.

### DETAILED DESCRIPTION OF EXEMPLARY EMBODIMENTS

Hereinafter, preferred embodiments of the present invention will be described in detail with reference to the accompanying drawings. The advantages and features of the present invention and the methods for achieving them will become apparent with reference to the embodiments described in detail below together with the accompanying drawings. However, the present invention is not limited to the embodiments described below, but may be implemented in various different forms, and these embodiments are provided only to make the invention of the present invention complete and to fully inform those skilled in the art of the scope of the invention, and the present invention is defined only by the scope of the claims. Like reference numerals refer to like elements throughout the specification.

In addition, the terminology used herein is for the purpose of describing embodiments and is not intended to limit and/or restrict the disclosed invention. The singular expression includes the plural expression unless the context clearly indicates otherwise. In this specification, the terms “comprises”, “include”, or “has” and the like are intended to specify that a feature, number, step, operation, component, part, or combination thereof described in the specification is present, but do not exclude in advance the possibility of the presence or addition of one or more other features, numbers, steps, operations, components, parts, or combinations thereof.

In addition, terms including ordinal numbers such as “first”, “second”, etc. used in this specification may be used to describe various components, but the components are not limited by the terms, and the terms are used only for the purpose of distinguishing one component from another. For example, without departing from the scope of the present invention, the first component may be named the second component, and similarly, the second component may also be named the first component. The term “and/or” includes a combination of multiple related described items or any item among multiple related described items.

Meanwhile, the terms “front”, “rear”, “upper”, “lower”, “front”, and “lower” used in the following description are defined based on the drawings, and the shape and position of each component are not limited by these terms.

The terms used in this specification are for describing embodiments and are not intended to limit the present invention. In this specification, the singular includes the plural unless specifically stated in the phrase. The terms “comprise” and/or “comprising” used in the specification do not exclude the presence or addition of one or more other components, steps, operations, and/or elements mentioned.

Unless otherwise defined, all terms (including technical and scientific terms) used in this specification may be used in a meaning that can be commonly understood by a person of ordinary skill in the art to which the present invention belongs. In addition, terms defined in commonly used dictionaries shall not be ideally or excessively interpreted unless explicitly specifically defined.

Hereinafter, embodiments of the present invention will be described in detail with reference to the attached drawings, and when describing with reference to the attached drawings, identical or corresponding components will be given the same reference numerals regardless of the drawing numbers, and redundant descriptions thereof will be omitted.

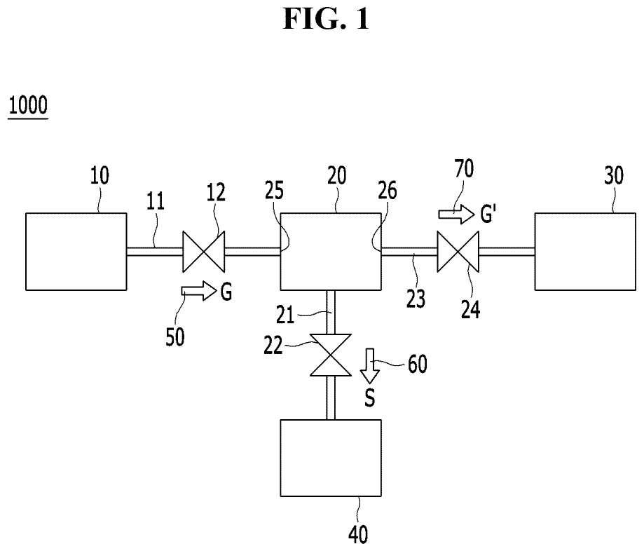

Hereinafter, first, a scrubbing system 1000 including a scrubbing apparatus 20 according to some embodiments of the present invention will be described with reference to FIG. 1. FIG. 1 is a drawing briefly explaining the scrubbing system including the scrubbing apparatus according to some embodiments of the present invention.

Referring to FIG. 1, the scrubbing system 1000 according to some embodiments of the present invention may include a process chamber 10, a scrubbing apparatus 20, an exhaust gas discharge chamber 30, and a cleaning solution discharge chamber 40.

The process chamber 10 may be a chamber utilized in various industrial fields. The various industrial fields may be a plant field, a battery field, a thermal power plant field, a steel field, a semiconductor field, a chemical field, and/or an oil and gas plant field.

If the scrubbing system 1000 is utilized in the semiconductor field, the process chamber 10 may be a chamber in which a semiconductor process is performed. In order to manufacture a semiconductor device, various semiconductor processes must be performed on a wafer. For example, a film must be deposited on the wafer(deposition process), and the film must be etched (etching process) to form a pattern included in the semiconductor device. In addition, after the deposition process and/or the etching process are performed, a cleaning process must be performed to clean the wafer and/or the process chamber 10.

The deposition process may include, for example, physical vapor deposition (PVD), chemical vapor deposition (CVD), and/or atomic layer deposition (ALD). The etching process may include, for example, a dry etching process, a wet etching process, and/or an ashing process. The cleaning process may include, for example, a wet cleaning process, a dry cleaning process, and/or a vapor cleaning process.

If the scrubbing system 1000 is utilized in the oil and gas plant industry, the process chamber 10 may be a chamber where the plant process is performed.

When various processes are performed in the process chamber 10, various byproducts may be generated. The byproducts may include substances harmful to the human body, and if the byproducts include substances harmful to the human body, they must be removed and discharged. The scrubbing apparatus 20 may be used to remove substances harmful to the human body and the byproducts generated in the process chamber 10.

A first pipe 11 may be disposed between the process chamber 10 and the scrubbing apparatus 20. One end of the first pipe 11 may be connected to the process chamber 10, and the other end of the first pipe 11 may be connected to the scrubbing apparatus 20. A gas G discharged from the process chamber 10 may be provided to the scrubbing apparatus 20 through the first pipe 11 (see reference numeral 50). The gas G may contain impurities. The impurities may be substances harmful to the human body. The impurities may contain hydrophilic substances and may also contain large particulate dust.

In some embodiments, a first valve 12 may be connected to the first pipe 11. The first valve 12 may control the pressure and flow rate of the gas G provided to the scrubbing apparatus 20 through the first pipe 11.

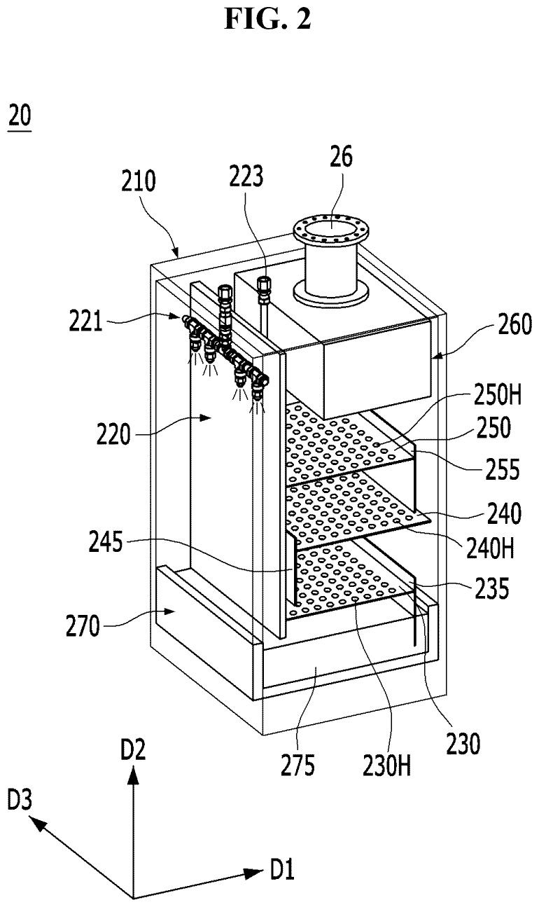

The scrubbing apparatus 20 may scrub the gas G provided from the process chamber 10. The impurities contained in the gas G may be dissolved in a cleaning solution and stored in the cleaning solution discharge chamber 40. The gas G′ from which the impurities have been removed may be stored in the exhaust gas discharge chamber 30. A detailed description of the scrubbing apparatus 20 will be described later using FIGS. 2 to 13.

The cleaning solution discharge chamber 40 may be connected to the scrubbing apparatus 20. The cleaning solution discharge chamber 40 and the scrubbing apparatus 20 may be connected to each other through a second pipe 21. One end of the second pipe 21 may be connected to the scrubbing apparatus 20, and the other end of the second pipe 21 may be connected to the cleaning solution discharge chamber 40. Through the second pipe 21, the cleaning solution S in which impurities are dissolved may move from the scrubbing apparatus 20 to the cleaning solution discharge chamber 40 (see reference numeral 60).

In some embodiments, a second valve 22 may be connected to the second pipe 21. The second valve 22 may control the pressure and flow rate of the cleaning solution S containing dissolved impurities, which is supplied to the cleaning solution discharge chamber 40 through the second pipe 21.

The exhaust gas discharge chamber 30 may be connected to the scrubbing apparatus 20. The exhaust gas discharge chamber 30 and the scrubbing apparatus 20 may be connected to each other through a third pipe 23. One end of the third pipe 23 may be connected to the scrubbing apparatus 20, and the other end of the third pipe 23 may be connected to the exhaust gas discharge chamber 30. Through the third pipe 23, the gas G′ from which impurities have been removed may move from the scrubbing apparatus 20 to the exhaust gas discharge chamber 30 (see reference numeral 70).

In some embodiments, a third valve 24 may be connected to the third pipe 23. The third valve 24 may control the pressure and flow rate of the gas G′ from which impurities have been removed and provided to the exhaust gas discharge chamber 30 through the third pipe 23.

In some embodiments, the scrubbing apparatus 20 may further include a gas inlet port 25 and a gas outlet port 26. The gas G may be introduced into the scrubbing apparatus 20 through the gas inlet port 25. The gas G′ from which impurities have been removed may be discharged to the exterior of the scrubbing apparatus 20 through the gas outlet port 26.

When the scrubbing apparatus 20 according to some embodiments of the present invention is utilized in the industrial field, pollutants generated after the process can be effectively separated and removed. Accordingly, environmental pollution problems can be reduced.

Hereinafter, a scrubbing apparatus according to some embodiments of the present invention will be described in detail with reference to FIGS. 2 to 5.

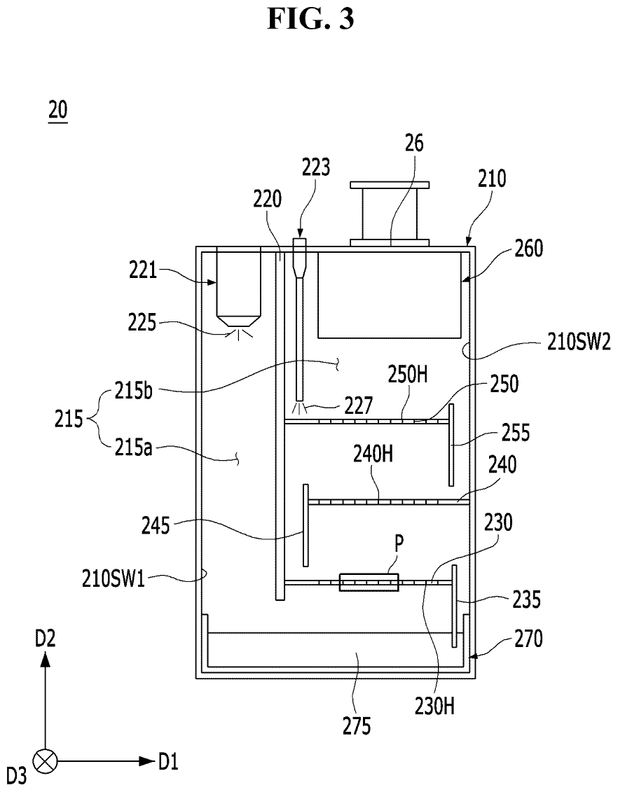

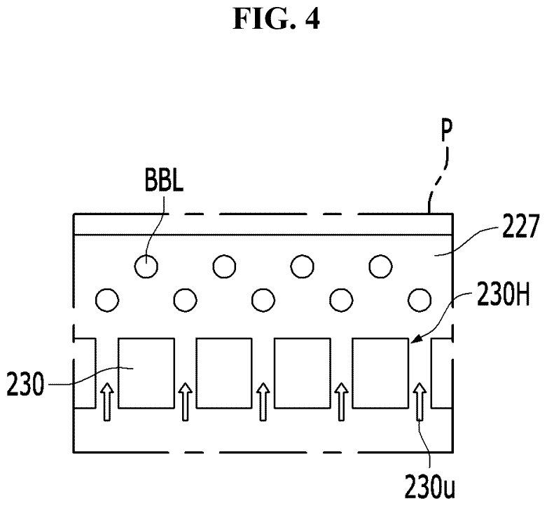

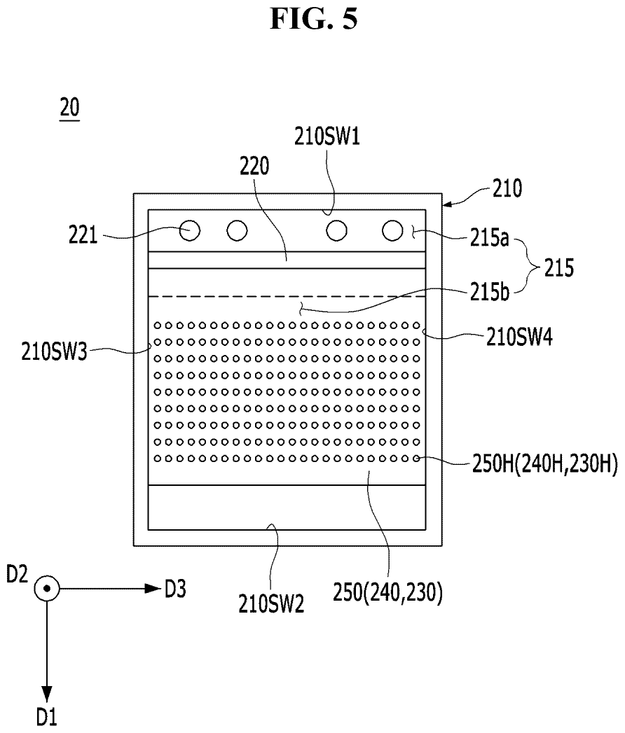

FIG. 2 is an exemplary perspective view for explaining the scrubbing apparatus of FIG. 1. FIG. 3 is an exemplary cross-sectional view for explaining the scrubbing apparatus of FIG. 1. FIG. 4 is an enlarged view of the P area of FIG. 3. FIG. 5 is an exemplary plan view for explaining the scrubbing apparatus of FIG. 1.

Referring to FIGS. 2 to 5, the scrubbing apparatus 20 according to some embodiments of the present invention may comprise a scrubbing chamber 210, a separating wall 220, a first scrubbing plate 230, a second scrubbing plate 240, a third scrubbing plate 250, a spray nozzle 221, a cleaning solution supply nozzle 223, and a demister 260.

First, the scrubbing chamber 210 may be provided. The scrubbing chamber 210 may be an outer housing of the scrubbing apparatus 20. The gas (G of FIG. 1) may be provided in the scrubbing chamber 210. The gas may contain impurities. For example, the gas (G of FIG. 1) may be provided into an interior of the scrubbing chamber 210 through the gas inlet port (25 of FIG. 1). The gas inlet port may be formed on an upper wall of the scrubbing chamber 210 or a side wall of the scrubbing chamber 210. Also, the gas inlet port may be formed on an upper part of the scrubbing chamber 210 or a lower part of the scrubbing chamber 210.

The impurities contained in the gas (G of FIG. 1) inside the scrubbing chamber 210 may be dissolved in the cleaning solution. The scrubbing chamber 210 may define a scrubbing space 215. The scrubbing space 215 may be a space where a scrubbing process is performed in which impurities contained in the gas (G of FIG. 1) are dissolved in the cleaning solution.

In some embodiments, the scrubbing space 215 may include a first sub-space 215a and a second sub-space 215b. The first sub-space 215a and the second sub-space 215b are divided by the separating wall 220. The first sub-space 215a and the second sub-space 215b are defined by the separating wall 220.

The separating wall 220 may be disposed in the scrubbing chamber 210. In some embodiments, the separating wall 220 may be attached to the upper wall of the scrubbing chamber 210. The separating wall 220 may extend from the upper wall of the scrubbing chamber 210 in a second direction D2. The second direction D2 may be a direction perpendicular to the ground.

In some embodiments, the separating wall 220 may have a bar shape in a planar view. The separating wall 220 may extend in a third direction D3 in a planar view. One end of the separating wall 220 may be connected to and in contact with a third inner side wall 210SW3 of the scrubbing chamber 210, and the other end of the separating wall 220 may be connected to and in contact with a fourth inner side wall 210SW4 of the scrubbing chamber 210. The separating wall 220 may include a long side extending in the third direction D3 and a short side extending in a first direction D1, but technical scope of the present invention is not limited thereto.

The separating wall 220 may define the first sub-space 215a and the second sub-space 215b. The separating wall 220 may divide the scrubber space 215 into the first sub-space 215a and the second sub-space 215b.

A first scrubbing process may be performed in the first sub-space 215a. A second scrubbing process may be performed in the second sub-space 215b. The first scrubbing process may be a process in which a first impurity is dissolved in a first cleaning solution 225. The second scrubbing process may be a process in which a second impurity is dissolved in a second cleaning solution 227. The first impurity and the second impurity may be included in a gas (G of FIG. 1) provided from the process chamber 10.

In some embodiments, the first cleaning solution 225 may be the same as or different from the second cleaning solution 227. Similarly, the first impurity and the second impurity may be the same as or different from each other. Details related to this will be described later.

In this specification, the first direction D1 and the third direction D3 may intersect each other. The first direction D1 and the second direction D2 may intersect each other. The second direction D2 and the third direction D3 may intersect each other. That is, in this specification, the first direction D1, the second direction D2, and the third direction D3 may be substantially perpendicular to each other.

The first scrubbing plate 230, the second scrubbing plate 240, and the third scrubbing plate 250 are disposed in the scrubbing space 215. Specifically, the first scrubbing plate 230, the second scrubbing plate 240, and the third scrubbing plate 250 are disposed in the second sub-space 215b.

In FIGS. 2 to 5, the scrubbing apparatus 20 of the present invention is illustrated as including three scrubbing plates, but the technical scope of the present invention is not limited thereto. The scrubbing apparatus 20 according to some embodiments of the present invention may include at least one scrubbing plate. That is, one or two scrubbing plates may be arranged inside the second sub-space 215b, or four or more may be arranged.

The first scrubbing plate 230 may be arranged at the lowest position among the scrubbing plates arranged inside the second sub-space 215b. One end of the first scrubbing plate 230 may be connected to and fixed to the separating wall 220. Specifically, one end of the first scrubbing plate 230 may be connected to and fixed to a side wall of the separating wall 220 facing the second sub-space 215b. The first scrubbing plate 230 may be connected to the separating wall 220 and may extend in the first direction D1 intersecting the separating wall 220. More specifically, the first scrubbing plate 230 may be disposed on a plane on which the first direction D1 and the third direction D3 extend.

In some embodiments, another portion of the first scrubbing plate 230 may be connected and fixed to the inner side walls of the scrubbing chamber 210. Specifically, the scrubbing chamber 210 may include a first inner side wall 210SW1, a second inner side wall 210SW2, the third inner side wall 210SW3, and the fourth inner side wall 210SW4.

The first inner side wall 210SW1 of the scrubbing chamber 210 may face the separating wall 220. The first inner side wall 210SW1 of the scrubbing chamber 210 and the separating wall 220 may define the first sub-space 215a. The second inner side wall 210SW2 of the scrubbing chamber 210 may face the first inner side wall 210SW1 of the scrubbing chamber 210 in the first direction D1.

The second inner side wall 210SW2 of the scrubbing chamber 210 and the separating wall 220 may define the second sub-space 215b. The third inner side wall 210SW3 of the scrubbing chamber 210 and the fourth inner side wall 210SW4 are connected to the second inner side wall 210SW2 of the scrubbing chamber 210, respectively. The third inner side wall 210SI3 of the scrubbing chamber 210 may face the fourth inner side wall 210SW4 of the scrubbing chamber 210 in the third direction D3.

In some embodiments, the first scrubbing plate 230 may be connected to the separating wall 220, the third inner side wall 210SW3 of the scrubbing chamber 210, and the fourth inner side wall 210SW4 of the scrubbing chamber 210 in the second sub-space 215b.

However, the first scrubbing plate 230 may not be fixedly connected to the second inner side wall 210SW2 of the scrubbing chamber 210. The first scrubbing plate 230 may be spaced apart from the second inner side wall 210SW2 of the scrubbing chamber 210 in the first direction D1. The space from the other end of the first scrubbing plate 230 to the second inner side wall 210SW2 of the scrubbing chamber 210 may be a space in which the second cleaning solution 227, which will be described later, flows downward (for example, in the second direction D2).

The scrubbing apparatus 20 according to some embodiments may further include a first scrubbing hole 230H and a first scrubbing wall 235.

The first scrubbing hole 230H may be formed inside the first scrubbing plate 230. The first scrubbing hole 230H may extend from a lower surface of the first scrubbing plate 230 to an upper surface of the first scrubbing plate 230. That is, the first scrubbing hole 230H may penetrate the first scrubbing plate 230 in the second direction D2. The gas (G of FIG. 1) may ascend in the second direction D2 by passing through the first scrubbing hole 230H (see reference numeral 230u).

The upper surface of the first scrubbing plate 230 may face the demister 260 to be described later, and the lower surface of the first scrubbing plate 230 may face the cleaning solution storage tank 270 to be described later.

The first scrubbing wall 235 may be attached to the other end of the first scrubbing plate 230. The first scrubbing wall 235 may be interposed between the first scrubbing plate 230 and the second inner side wall 210SW2 of the scrubbing chamber 210. The first scrubbing wall 235 may extend in the second direction D2. In some embodiments, a portion of the first scrubbing wall 235 may protrude from the upper surface of the first scrubbing plate 230 in the second direction D2. Another portion of the first scrubbing wall 235 may protrude from the lower surface of the first scrubbing plate 230 in the second direction D2.

The length in the second direction D2 of the portion of the first scrubbing wall 235 protruding from the upper surface of the first scrubbing plate 230 may be less than the length in the second direction D2 of the portion protruding from the lower surface of the first scrubbing plate 230, but the technical scope of the present invention is not limited thereto.

In some embodiments, at least a portion of the first scrubbing plate 230 protruding from the lower surface of the first scrubbing wall 235 in the second direction D2 may be placed in the cleaning solution 275 in which impurities are dissolved, but the technical scope of the present invention is not limited thereto.

The second scrubbing plate 240 may be disposed on the first scrubbing plate 230. Specifically, the second scrubbing plate 240 may be disposed on the upper surface of the first scrubbing plate 230. One end of the second scrubbing plate 240 may be connected to and fixed to the second inner side wall 210SW2 of the scrubbing chamber 210. The second scrubbing plate 240 may be connected to the second inner side wall 210SW2 of the scrubbing chamber 210 and may extend in the first direction D1 intersecting the second inner side wall 210SW2 of the scrubbing chamber 210. More specifically, the second scrubbing plate 240 may be placed on a plane on which the first direction D1 and the third direction D3 extend.

Similarly, the second scrubbing plate 240 may be connected to and fixed to the third inner side wall 210SW3 of the scrubbing chamber 210 and the fourth inner side wall 210SW4 of the scrubbing chamber 210.

However, the other end of the second scrubbing plate 240 may not be fixedly connected to the separating wall 220. The other end of the second scrubbing plate 240 may be spaced apart from the side wall of the separating wall 220 in the first direction D1. The space from the other end of the second scrubbing plate 240 to the separating wall 220 may be a space in which the second cleaning solution 227, which will be described later, flows downward (for example, in the second direction D2).

In some embodiments, the scrubbing apparatus 20 according to some embodiments may further include a second scrubbing hole 240H and a second scrubbing wall 245.

The second scrubbing hole 240H may be formed inside the second scrubbing plate 240. The second scrubbing hole 240H may extend from a lower surface of the second scrubbing plate 240 to an upper surface of the second scrubbing plate 240. The second scrubbing hole 240H may penetrate the second scrubbing plate 240 in the second direction D2. The gas (G of FIG. 1) may ascend in the second direction D2 by passing through the second scrubbing hole 240H.

The upper surface of the second scrubbing plate 240 may face the demister 260 to be described later, and the lower surface of the second scrubbing plate 240 may face the upper surface of the first scrubbing plate 230.

The second scrubbing wall 245 may be attached to the other end of the second scrubbing plate 240. The second scrubbing wall 245 may be interposed between the second scrubbing plate 240 and the separating wall 220. The second scrubbing wall 245 may extend in the second direction D2. In some embodiments, a portion of the second scrubbing wall 245 may protrude from the upper surface of the second scrubbing plate 240 in the second direction D2. Another portion of the second scrubbing wall 245 may protrude from the lower surface of the second scrubbing plate 240 in the second direction D2.

A length in the second direction D2 of the portion protruding in the second direction D2 from the upper surface of the second scrubbing plate 240 among the second scrubbing wall 245 may be less than a length in the second direction D2 of the portion protruding in the second direction D2 from the lower surface of the second scrubbing plate 240, but the technical scope of the present invention is not limited thereto.

In some embodiments, the first scrubbing plate 230 and the second scrubbing plate 240 do not completely overlap in the second direction D2. The first scrubbing plate 230 and the second scrubbing plate 240 may be arranged in a zigzag configuration. Accordingly, the second cleaning solution 227 that flows downward over the second scrubbing wall 245 may be discharged onto the upper surface of the first scrubbing plate 230. In other words, a center of the first scrubbing plate 230 and a center of the second scrubbing plate 240 may be offset from each other.

The third scrubbing plate 250 may be disposed on the second scrubbing plate 240. Specifically, the third scrubbing plate 250 may be disposed on the upper surface of the second scrubbing plate 240. One end of the third scrubbing plate 250 may be connected to and fixed to the separating wall 220.

Specifically, one end of the third scrubbing plate 250 may be connected and fixed to the side wall of the separating wall 220 facing the second sub-space 215b. The third scrubbing plate 250 may be connected to the separating wall 220 and may extend in a first direction D1 intersecting the separating wall 220. More specifically, the third scrubbing plate 250 may be placed on a plane along which the first direction D1 and the third direction D3 extend. Similarly, the third scrubbing plate 250 may be connected and fixed to the third inner side wall 210SW3 of the scrubbing chamber 210 and the fourth inner side wall 210SW4 of the scrubbing chamber 210.

However, the other end of the third scrubbing plate 250 may not be connected to and fixed to the second inner side wall 210SW2 of the scrubbing chamber 210. The other end of the third scrubbing plate 250 may be spaced apart from the second inner side wall 210SW2 of the scrubbing chamber 210 in the first direction D1. The space from the other end of the third scrubbing plate 250 to the second inner side wall 210SW2 of the scrubbing chamber 210 may be a space in which the second cleaning solution 227, which will be described later, flows downward (for example, in the second direction D2).

The scrubbing apparatus 20 according to some embodiments may further include a third scrubbing hole 250H and a third scrubbing wall 255.

The third scrubbing hole 250H may be formed inside the third scrubbing plate 250. The third scrubbing hole 250H may extend from the lower surface of the third scrubbing plate 250 to the upper surface of the third scrubbing plate 250. The third scrubbing hole 250H may penetrate the third scrubbing plate 250 in the second direction D2. The gas (G of FIG. 1) may ascend in the second direction D2 by passing through the third scrubbing hole 250H.

The upper surface of the third scrubbing plate 250 may face the demister 260 to be described later, and the lower surface of the third scrubbing plate 250 may face the upper surface of the second scrubbing plate 240.

The third scrubbing wall 255 may be attached to the other end of the third scrubbing plate 250. The third scrubbing wall 255 may be interposed between the third scrubbing plate 250 and the second inner side wall 210SW2 of the scrubbing chamber 210. The third scrubbing wall 255 may extend in the second direction D2.

In some embodiments, a portion of the third scrubbing wall 255 may protrude in the second direction D2 from the upper surface of the third scrubbing plate 250. Another portion of the third scrubbing wall 255 may protrude in the second direction D2 from the lower surface of the third scrubbing plate 250.

A length in the second direction D2 of the portion protruding in the second direction D2 from the upper surface of the third scrubbing plate 250 among the third scrubbing wall 255 may be less than a length in the second direction D2 of the portion protruding in the second direction D2 from the lower surface of the third scrubbing plate 250, but the technical scope of the present invention is not limited thereto.

In some embodiments, the third scrubbing plate 250 and the second scrubbing plate 240 do not completely overlap in the second direction D2. The third scrubbing plate 250 and the second scrubbing plate 240 may be arranged in a zigzag configuration. The second cleaning solution 227 that flows downward over the third scrubbing wall 255 may be discharged onto the upper surface of the second scrubbing plate 240. In other words, a center of the third scrubbing plate 250 and the center of the second scrubbing plate 240 may be offset from each other.

However, the third scrubbing plate 250 and the first scrubbing plate 230 may completely overlap in the second direction D2. That is, the center of the third scrubbing plate 250 and the center of the first scrubbing plate 230 may overlap in the second direction D2.

In some embodiments, the first to third scrubbing holes 230H, 240H, 250H may completely overlap in the second direction D2. However, the technical scope of the present invention is not limited thereto. The first to third scrubbing holes 230H, 240H, 250H may not completely overlap in the second direction D2, and may only partially overlap.

The cleaning solution supply nozzle 223 may be disposed in the scrubbing chamber 210. The cleaning solution supply nozzle 223 may be connected to the upper part of the scrubbing chamber 210 and may extend in the second direction D2. The cleaning solution supply nozzle 223 may be connected to a pipe (not shown) installed outside the scrubbing chamber 210. The cleaning solution supply nozzle 223 may supply the second cleaning solution 227 to the second sub-space 215b. The second cleaning solution 227 may be supplied from the cleaning solution supply nozzle 223 and discharged to the upper surface of the third scrubbing plate 250.

The second cleaning solution 227 may be, for example, water. However, the technical scope of the present invention is not limited thereto.

The second cleaning solution 227 may be discharged onto the upper surface of the third scrubbing plate 250 and may flow from the upper surface of the third scrubbing plate 250 toward the third scrubbing wall 255 while the second scrubbing process is being performed. At this time, the second cleaning solution 227 does not flow downward through the third scrubbing hole 250H. The second cleaning solution 227 may flow over the third scrubbing wall 255 to the lower part of the scrubbing chamber 210.

The second scrubbing process may mean a process in which some of the impurities contained in the gas are dissolved in the second cleaning solution 227 in the second sub-space 215b.

The second cleaning solution 227 that has passed over the third scrubbing wall 255 is discharged again to the upper surface of the second scrubbing plate 240. The second cleaning solution 227 may flow from the upper surface of the second scrubbing plate 240 toward the second scrubbing wall 245 while the second scrubbing process is performed. At this time, the second cleaning solution 227 does not flow downward through the second scrubbing hole 240H. The second cleaning solution 227 may flow over the second scrubbing wall 245 to the lower part of the scrubbing chamber 210.

Similarly, the second cleaning solution 227 that has passed over the second scrubbing wall 245 is discharged again to the upper surface of the first scrubbing plate 230. The second cleaning solution 227 may flow from the upper surface of the first scrubbing plate 230 toward the first scrubbing wall 235 while the second scrubbing process is performed. At this time, the second cleaning solution 227 does not flow downward through the first scrubbing hole 230H. The second cleaning solution 227 may flow over the first scrubbing wall 235 to the lower part of the scrubbing chamber 210.

Finally, the second cleaning solution 227 that has passed over the first scrubbing wall 235 may be stored in the cleaning solution storage tank 270 provided at the lower part of the scrubbing chamber 210. The cleaning solution storage tank 270 may store a cleaning solution 275 in which impurities are dissolved. For example, the cleaning solution 275 in which impurities are dissolved may be a solution in which a hydrophilic gas is dissolved in the second cleaning solution 227. In addition, the cleaning solution 275 in which impurities are dissolved may be a solution in which a hydrophilic gas and/or dust are dissolved in the first cleaning solution 225.

In some embodiments, the hydrophilic gas may be isopropyl alcohol (IPA) and/or ammonia, although the technical scope of the present invention is not limited thereto.

The demister 260 may be disposed on the upper part of the scrubbing chamber 210. The demister 260 may be used to remove moisture from the gas after the first scrubbing process and the second scrubbing process are performed. After the first scrubbing process and the second scrubbing process are performed, the gas (G′ of FIG. 1) from which impurities have been removed may be provided. That is, moisture may be removed from the gas (G′ of FIG. 1) from which impurities have been removed after the first scrubbing process and the second scrubbing process are performed using the demister 260.

The demister 260 may be connected to the gas outlet port 26. The gas filtered through the demister 260 may be discharged to the outside of the scrubbing chamber 210 through the gas outlet port 26.

When using the scrubbing apparatus 20 according to some embodiments, gases harmful to the human body (e.g., impurities) may be dissolved in the cleaning solution. Accordingly, gases harmful to the human body may be removed from byproducts generated after various processes are performed in various industrial fields and discharged to the outside of the scrubbing chamber 210.

In some embodiments, the first sub-space 215a may be defined by the first inner side wall 210SW1 of the scrubbing chamber 210 and the separating wall 220. For example, the first sub-space 215a may be defined by the first inner side wall 210SW1 of the scrubbing chamber 210, the third inner side wall 210SW3 of the scrubbing chamber 210, the fourth inner side wall 210SW4 of the scrubbing chamber 210, and the separating wall 220. The first inner side wall 210SW1 of the scrubbing chamber 210 may face the separating wall 220.

The first scrubbing process may be performed in the first sub-space 215a. The first scrubbing process may mean a process in which some of the impurities contained in the gas in the first sub-space 215a are dissolved in the first cleaning solution 225.

In some embodiments, the first cleaning solution 225 may be provided into the interior of the scrubbing chamber 210 through the spray nozzle 221. The first cleaning solution 225 may be provided into the first sub-space 215a through the spray nozzle 221.

The first cleaning solution 225 may be provided from the upper part to the lower part of the first sub-space 215a, and while the gas (G of FIG. 1) flows from the upper part to the lower part of the first sub-space 215a, at least some of the impurities contained in the gas may be dissolved in the first cleaning solution 225. In some embodiments, the first cleaning solution 225 may include water. However, the technical scope of the present invention is not limited thereto. In other embodiments, the first cleaning solution 225 may not be water. The first cleaning solution 225 may include a viscous substance.

In some embodiments, the spray nozzle 221 may be a spray nozzle. The spray nozzle 221 may supply the first cleaning solution 225 having small particles to the first sub-space 215a. Accordingly, the contact area between the first cleaning solution 225 and the gas may be increased. Accordingly, the scrubbing apparatus 20 with improved scrubbing efficiency may be provided.

The spray nozzle 221 may be installed on the upper part of the scrubbing chamber 210. Although not shown, the spray nozzle 221 may be connected to a pipe installed outside the scrubbing chamber 210.

In some embodiments, the spray nozzle 221 and the cleaning solution supply nozzle 223 may each be connected to the cleaning solution storage tank 270 through a pipe (not shown) that is connected to the cleaning solution storage tank 270. That is, the first cleaning solution 225 provided to the first sub-space 215a through the spray nozzle 221 may be the cleaning solution 275 stored in the cleaning solution storage tank 270 in which impurities are dissolved. Similarly, the second cleaning solution 227 provided to the second sub-space 215b through the cleaning solution supply nozzle 223 may be the cleaning solution 275 stored in the cleaning solution storage tank 270 in which impurities are dissolved.

Thus, when using the scrubbing apparatus 20 of the present invention, the cleaning solution may be recycled, and accordingly, the amount of cleaning solution used in the scrubbing process may be reduced.

In some embodiments, the first cleaning solution 225 may be different from the second cleaning solution 227. For example, the first cleaning solution 225 may be a viscous substance and the second cleaning solution 227 may be a non-viscous substance.

In this case, the first impurity dissolved in the first cleaning solution 225 and the second impurity dissolved in the second cleaning solution 227 may be different from each other. For example, a particle size of the first impurity dissolved in the first cleaning solution 225 may be larger than a particle size of the second impurity dissolved in the second cleaning solution 227. For example, the first impurity may be dust, and the second impurity may be a hydrophilic gas. However, the technical scope of the present invention is not limited thereto.

In other words, the first scrubbing process performed in the first sub-space 215a and the second scrubbing process performed in the second sub-space 215b may be different from each other. However, the technical scope of the present invention is not limited thereto.

In some embodiments, the gas inlet port may be installed on one side of the first sub-space 215a. The gas (G of FIG. 1) introduced into the interior of the scrubbing chamber 210 may be introduced into the interior of the scrubbing chamber 210 through the gas inlet port. The gas inlet port may be connected to the first pipe 11, and since the other side of the first pipe 11 is connected to the process chamber (10 of FIG. 1), the gas (G of FIG. 1) injected into the gas inlet port may be provided from the process chamber.

In some embodiments, a negative pressure may be provided to the scrubbing space 215 through the gas inlet port and the gas outlet port 26. For example, the pressure at the gas inlet port and the pressure at the gas outlet port 26 may be different from each other. Accordingly, the gas (G of FIG. 1) may flow from the gas inlet port toward the gas outlet port 26. The first scrubbing process and the second scrubbing process may be performed by utilizing the difference between the pressure at the gas inlet port and the pressure at the gas outlet port 26.

In some embodiments, the first sub-space 215a and the second sub-space 215b may be connected to each other at the lower part of the scrubbing chamber 210. The first sub-space 215a and the second sub-space 215b may be connected to each other above the cleaning solution storage tank 270.

That is, the gas injected into the first sub-space 215a may flow from the upper part of the first sub-space 215a to the lower part of the first sub-space 215a and may be introduced into the second sub-space 215b from the lower part of the scrubbing chamber 210. In the second sub-space 215b, the gas (G of FIG. 1) may ascent in the second direction D2.

When using the scrubbing apparatus 20 according to some embodiments, the contact area between the cleaning solution and the gas may be increased. Specifically, bubbles may be formed within the cleaning solution to increase the contact area between the cleaning solution and the gas.

For example, in FIG. 4, the gas (G of FIG. 1) may pass through the first scrubbing hole 230H and ascend in the second direction D2 (see reference numeral 230u).

After the gas (G of FIG. 1) may ascend through the first scrubbing hole 230H, bubbles BBL may be formed on the upper surface of the first scrubbing plate 230. The bubbles may be formed inside the second cleaning solution 227. The impurities contained in the gas may dissolve into the second cleaning solution 227 at the contact area between the bubbles BBL and the second cleaning solution 227.

Although not shown, the gas (G of FIG. 1) may ascend through the first scrubbing hole 230H and then continue to ascend through the second scrubbing hole 240H in the second direction D2. After the gas (G of FIG. 1) ascends through the second scrubbing hole 240H, the bubbles may be formed on the upper surface of the second scrubbing plate 240. Similarly, after the gas (G of FIG. 1) ascends through the second scrubbing hole 240H, the gas may ascend through the third scrubbing hole 250H in the second direction D2. After the gas (G of FIG. 1) ascends through the third scrubbing hole 250H, the bubbles may be formed on the upper surface of the third scrubbing plate 250.

When the bubbles BBL are formed in the second cleaning solution 227, the contact area between the gas and the cleaning solution may be increased. Accordingly, the scrubbing apparatus 20 with improved scrubbing efficiency may be provided.

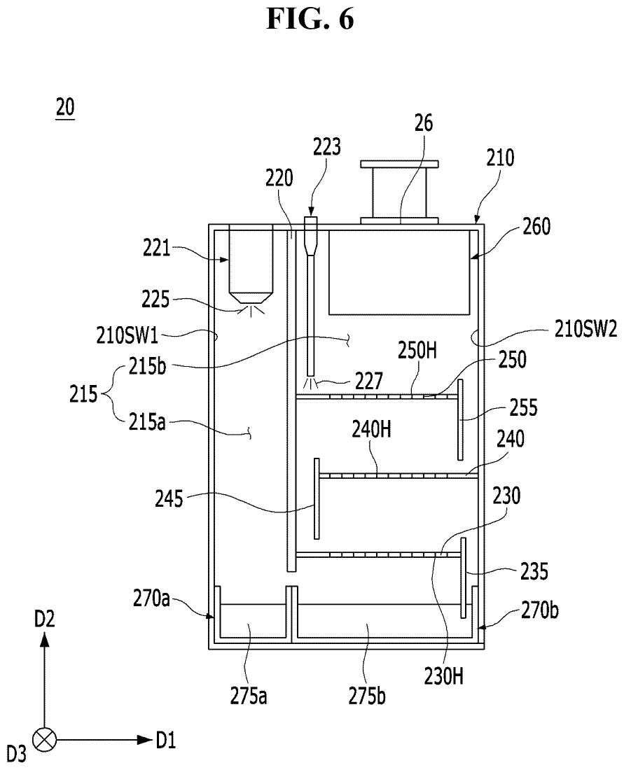

Hereinafter, the scrubbing apparatus according to some other embodiments of the present invention will be described with reference to FIGS. 6 to 13. For convenience of explanation, any content that overlaps with the content described using FIGS. 2 to 5 will be briefly described or omitted.

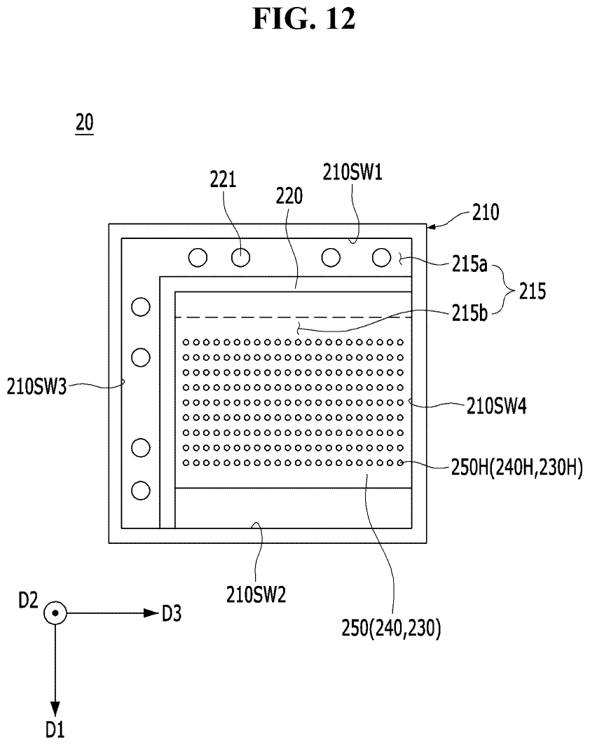

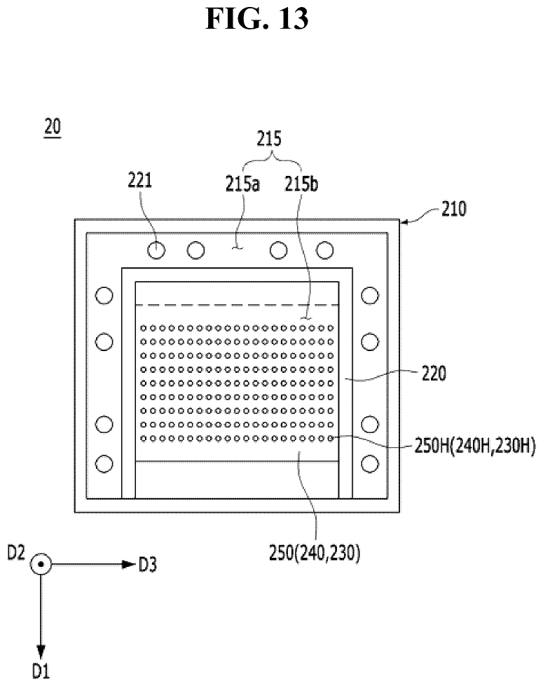

FIGS. 6 to 13 are drawings for explaining the scrubbing apparatus according to some other embodiments of the present invention, respectively. For reference, FIGS. 6, 7, 8, 9, 10, and 11 may be cross-sectional views of scrubbing apparatus according to some other embodiments of the present invention, respectively, and FIGS. 12 and 13 may be plan views of scrubbing apparatus according to some other embodiments of the present invention, respectively.

First, referring to FIG. 6, in the scrubbing apparatus 20 according to some embodiments, the cleaning storage tank may include a first tank 270a and a second tank 270b.

The first tank 270a and the second tank 270b may be physically separated. The first tank 270a may be disposed on the lower part of the first sub-space 215a, and the second tank 270b may be disposed on the lower part of the second sub-space 217b.

In some embodiments, the first cleaning solution 225 and the second cleaning solution 227 may be different each other. In this case, the first impurity dissolved in the first cleaning solution 225 and the second impurity dissolved in the second cleaning solution 227 may also be different from each other. The first cleaning solution 275a, in which the first impurity is dissolved and the second cleaning solution 275b in which the second impurity is dissolved need to be stored in different tanks. This is because the first cleaning solution 275a in which the first impurity is dissolved and the second cleaning solution 275b in which the second impurity is dissolved should not be mixed with each other so that they may be recycled later and used in the scrubbing process.

Therefore, the first tank 270a and the second tank 270b may be physically separated.

In some embodiment, the first cleaning solution 275a in which the first impurity is dissolved, stored in the first tank 270a, may be provided to the first sub-space 215a through the spray nozzle 221. Similarly, the second cleaning solution 275b in which the second impurity is dissolved, stored in the second tank 270b, may be provided to the second sub-space 215b through the cleaning solution supply nozzle 223. However, the technical scope of the present invention is not limited thereto.

In some embodiments, although not shown, the scrubbing apparatus 20 may further include a sub-cleaning solution supply nozzle. The sub-cleaning solution supply nozzle may be disposed on the upper part of the scrubbing chamber 210. The sub-cleaning solution supply nozzle may supply the cleaning solution to the upper surface of the third scrubbing plate 250.

The sub-cleaning solution supply nozzle may supply cleaning solution with small particles onto the upper surface of the third scrubbing plate 250. Accordingly, the contact area between the cleaning solution and the gas may be increased. Accordingly, the scrubbing apparatus 20 with improved scrubbing efficiency may be provided.

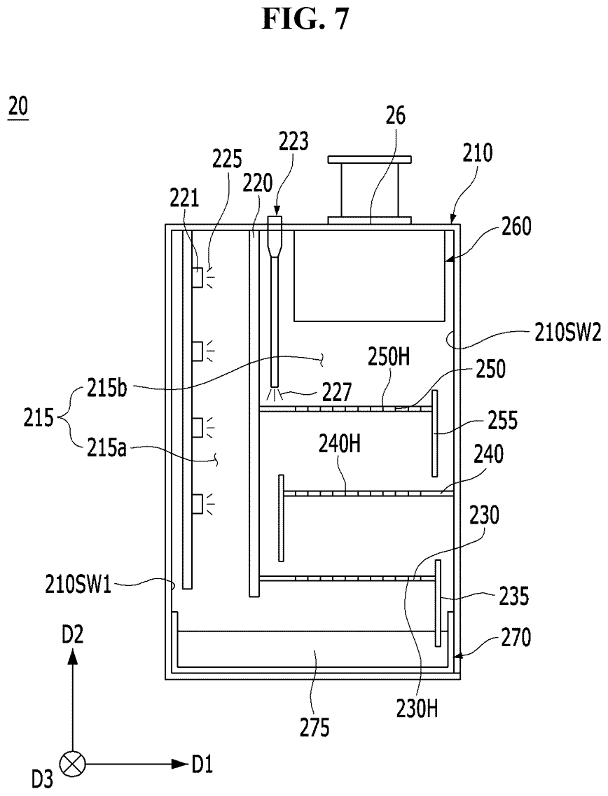

Referring to FIG. 7, the spray nozzle 221 may spray the first cleaning solution 225 in the first direction D1. A direction in which the first cleaning solution 225 is sprayed may be parallel to a direction in which the scrubbing plate 230, 240, 250 extend. The direction in which the first cleaning solution 225 is sprayed may intersect the second direction D2. The direction in which the first cleaning solution 225 is sprayed may intersect the direction in which the gas flows (e.g., the second direction D2).

Specifically, the scrubbing apparatus 20 according to some embodiments may further include a pipe that is disposed on the upper part of the scrubbing chamber 210 and extends in the second direction D2 in the first sub-space 215a. The spray nozzle 221 may be connected to the pipe and directed in the first direction D1.

The first cleaning solution 225 may be sprayed in the first direction D1 in the first sub-space 215a. The gas (G of FIG. 1) may descend in the second direction D2 in the first sub-space 215a. That is, the direction in which the first cleaning solution 225 is sprayed and the direction in which the gas (G of FIG. 1) moves may be substantially perpendicular. Since the first cleaning solution 225 is not sprayed in the second direction D2, the contact time between the first cleaning solution 225 and the gas (G of FIG. 1) may be substantially improved, and accordingly, the scrubbing apparatus 20 with increased efficiency may be provided.

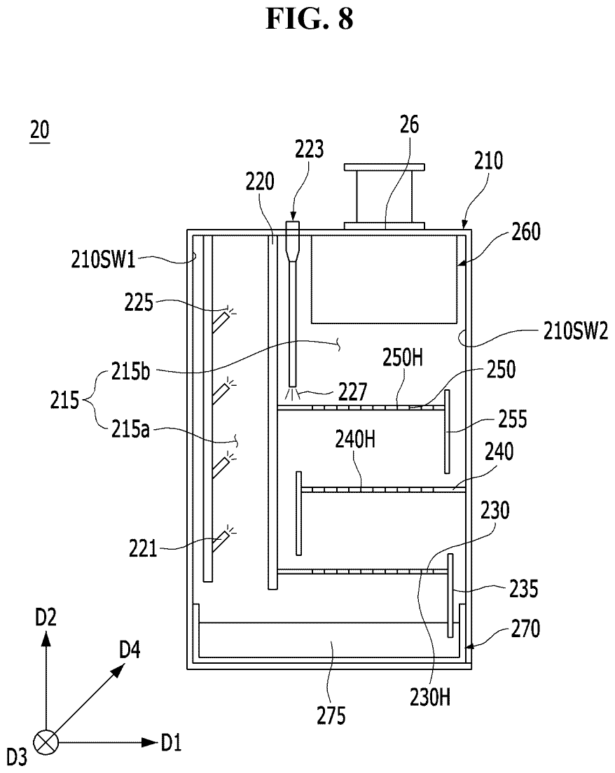

Referring to FIG. 8, the spray nozzle 221 may spray the first cleaning solution 225 in a fourth direction D4. The fourth direction D4 may be any direction between the second direction D2 and the first direction D1. That is, the first cleaning solution 225 may be sprayed in any direction intersecting the first direction D1 and the second direction D2.

Specifically, the scrubbing apparatus 20 according to some embodiments may further include a pipe that is disposed on the upper part of the scrubbing chamber 210 and extends in a second direction D2. The spray nozzle 221 may be connected to the pipe and directed in the fourth direction D4.

The first cleaning solution 225 may be sprayed in the fourth direction D4 intersecting the first direction D1 and the second direction D2 in the first sub-space 215a. In the first sub-space 215a, the gas (G of FIG. 1) may descend in the second direction D2. That is, the direction in which the first cleaning solution 225 is sprayed and the direction in which the gas (G of FIG. 1) moves may intersect. Since the first cleaning solution 225 is not sprayed in the second direction D2, the contact time between the first cleaning solution 225 and the gas (G of FIG. 1) may be substantially improved, and accordingly, the scrubbing apparatus 20 with increased efficiency may be provided.

More specifically, the first cleaning solution 225 is sprayed in the second direction D2 and also in the first direction D1. Since the first cleaning solution 225 is sprayed in a direction opposite to the direction in which the gas flows (e.g., the second direction D2), the contact time between the first cleaning solution 225 and the gas may be increased, thereby improving the cleaning efficiency.

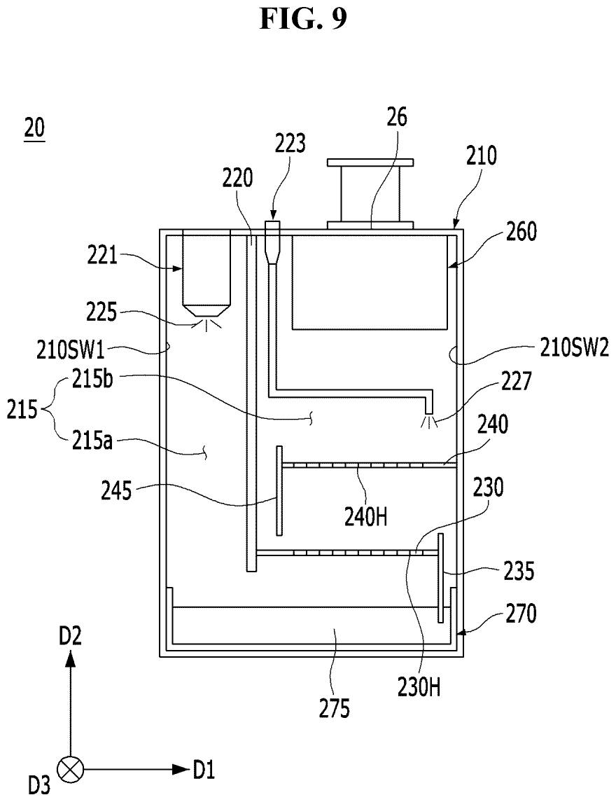

Referring to FIG. 9, the scrubbing apparatus 20 according to some embodiments may include two scrubbing plates 230 and 240. That is, the scrubbing apparatus 20 may include the first scrubbing plate 230 and the second scrubbing plate 240.

The second scrubbing plate 240 may be disposed on the first scrubbing plate 230. The second scrubbing plate 240 may be disposed on the upper surface of the first scrubbing plate 230. The first scrubbing plate 230 may be disposed on the lower surface of the second scrubbing plate 240. Another scrubbing plate may not be disposed on the upper surface of the second scrubbing plate 240.

In some embodiment, the second cleaning solution 227 may be supplied from the cleaning solution supply nozzle 223 and discharged to the upper surface of the second scrubbing plate 240. Specifically, the second cleaning solution 227 may be discharged to an area adjacent to the second inner side wall 210SW2 of the scrubbing chamber 210 among the upper surface of the second scrubbing plate 240. The second cleaning solution 227 may be discharged to an area farthest from the second scrubbing wall 245 among the upper surface of the second scrubbing plate 240.

The discharged second cleaning solution 227 may flow from the upper surface of the second scrubbing plate 240 toward the second scrubbing wall 245 while the second scrubbing process is performed. The second cleaning solution 227 may flow downward over the second scrubbing wall 245. At this time, the second cleaning solution 227 does not flow downward through the second scrubbing hole 240H. The second cleaning solution 227 that flows downward over the second scrubbing wall 245 may be discharged on the upper surface of the first scrubbing plate 230.

Likewise, the second cleaning solution 227 may flow from the upper surface of the first scrubbing plate 230 toward the first scrubbing wall 235 while the second scrubbing process is performed. At this time, the second cleaning solution 227 does not flow downward through the first scrubbing hole 230H. The second cleaning solution 227 may flow over the first scrubbing wall 235 to the lower part of the scrubbing chamber 210.

The scrubbing apparatus 20 illustrated in FIG. 9 includes only two scrubbing plates 230 and 240. Therefore, the height of the scrubbing apparatus 20 in the second direction D2 may be reduced. That is, when the scrubbing apparatus 20 according to some embodiments of the present invention is used, space efficiency may be improved.

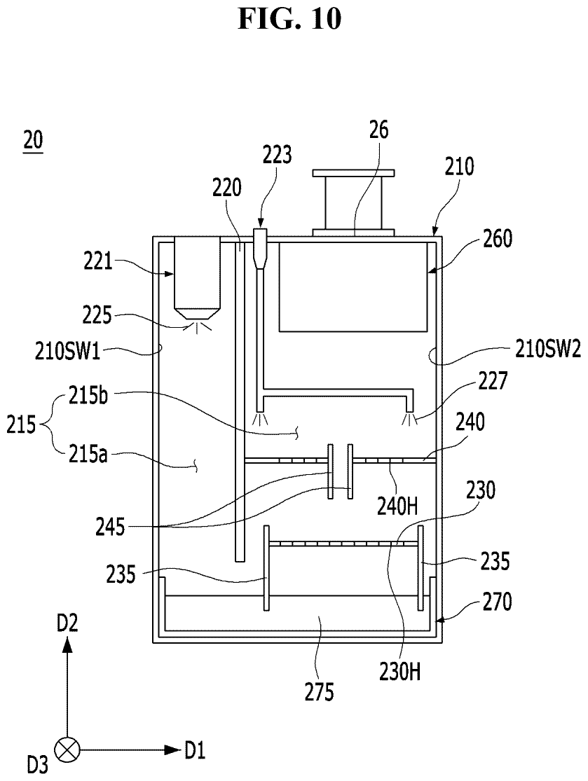

Referring to FIG. 10, in the scrubbing apparatus 20 according to some embodiments, the shape of the first scrubbing plate 230 and the shape of the second scrubbing plate 240 may be different from each other.

For example, the two ends of the first scrubbing plate 230 may be spaced apart from the separating wall 220 and the second inner side wall 210SW2, respectively. Specifically, the first scrubbing plate 230 may not be in contact with and connected to both the separating wall 220 and the second inner side wall 210SW2. Although not shown, the first scrubbing plate 230 may be in contact with and connected to the third inner side wall 210SW3 and the fourth inner side wall 210SW4. The first scrubbing plate 230 may extend in the third direction D3.

A pair of first scrubbing walls 235 may be arranged at one end and the other end of the first scrubbing plate 230. Some of the pair of first scrubbing walls 235 may be interposed between the first scrubbing plate 230 and the separating wall 220. Others of the pair of first scrubbing walls 235 may be interposed between the first scrubbing plate 230 and the second inner side wall 210SW2.

The space between the first scrubbing wall 235 and the separating wall 220 and the space between the first scrubbing wall 235 and the second inner side wall 210SW2 may each be a space in which the second cleaning solution 227 flows downward (for example, in the second direction D2).

On the other hand, the two ends of the second scrubbing plate 240 may be connected to the separating wall 220 and the second inner side wall 210SW2, respectively. The second scrubbing plate 240 may have a structure in which the central portion is open.

That is, the second scrubbing plate 240 may have an opening. The opening may be formed in the central portion of the second scrubbing plate 240 and may extend in the third direction D3. The opening may expose at least a portion of the upper surface of the first scrubbing plate 230. That is, the opening may overlap at least a portion of the upper surface of the first scrubbing plate 230 in the second direction D2.

A pair of second scrubbing walls 245 may be respectively positioned at the central portion of the second scrubbing plate 240. The pair of second scrubbing walls 245 may each be positioned at the opening.

The pair of second scrubbing walls 245 may be spaced apart from each other in the first direction D1. The space between the pair of second scrubbing walls 245 may be a space in which the second cleaning solution 227 flows downward (for example, in the second direction D2). That is, the second cleaning solution 227 may flow downward through the opening.

In some embodiments, the second cleaning solution 227 may be discharged to both ends of the second scrubbing plate 240. For example, the second cleaning solution 227 may be discharged to an area adjacent to the separating wall 220 of the second scrubbing plate 240 and an area adjacent to the second inner side wall 210SW2 of the second scrubbing plate 240.

The second cleaning solution 227 discharged from the upper surface of the second scrubbing plate 240 may flow to the central portion of the second scrubbing plate 240. The second cleaning solution 227 discharged from the upper surface of the second scrubbing plate 240 may flow into the opening. While the second cleaning solution 227 flows to the central portion of the second scrubbing plate 240, impurities may be dissolved in the second cleaning solution 227. The second cleaning solution 227 may be discharged to the upper surface of the first scrubbing plate 230 over the second scrubbing wall 245. The second cleaning solution 227 discharged from the upper surface of the first scrubbing plate 230 may flow to both ends of the first scrubbing plate 230.

In FIG. 10, the scrubbing apparatus 20 is illustrated as including two scrubbing plates, but the technical scope of the present invention is not limited thereto. If the scrubbing apparatus 20 includes three scrubbing plates, the shape of the third scrubbing plate may be the same as the shape of the first scrubbing plate 230. The third scrubbing plate may be disposed on the second scrubbing plate 240.

If the scrubbing apparatus 20 includes four scrubbing plates, the shape of the third scrubbing plate may be the same as the shape of the first scrubbing plate 230, and the shape of the fourth scrubbing plate may be the same as the shape of the second scrubbing plate 240. The third scrubbing plate may be disposed on the second scrubbing plate 240, and the fourth scrubbing plate may be disposed on the third scrubbing plate.

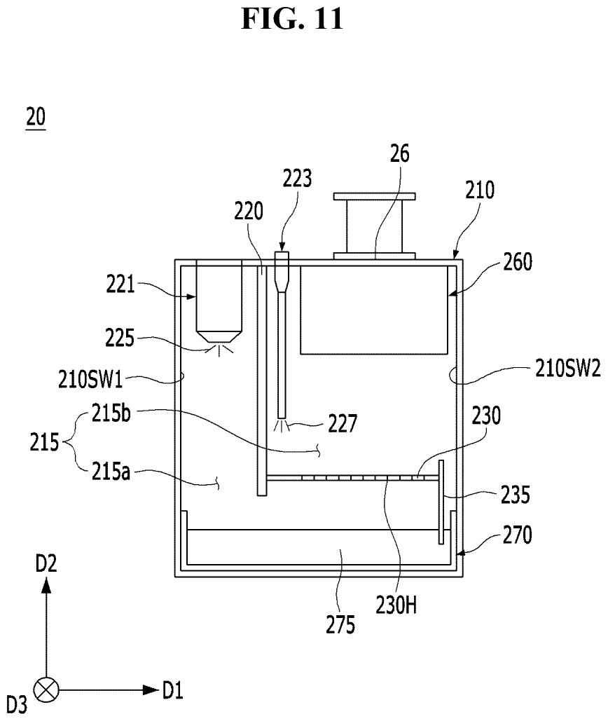

Referring FIG. 11, the scrubbing apparatus 20 according to some embodiments may include one scrubbing plate 230. That is, the scrubbing apparatus 20 may include the first scrubbing plate 230.

In some embodiments, the second cleaning solution 227 may be supplied from the cleaning solution supply nozzle 223 and discharged to the upper surface of the first scrubbing plate 230. Specifically, the second cleaning solution 227 may be discharged to an area adjacent to the separating wall 220 on the upper surface of the first scrubbing plate 230. The second cleaning solution 227 may be discharged to an area farthest from the first scrubbing wall 235 on the upper surface of the first scrubbing plate 230.

The second cleaning solution 227 may flow from the upper surface of the first scrubbing plate 230 toward the first scrubbing wall 235 while the second scrubbing process is performed. At this time, the second cleaning solution 227 does not flow downward through the first scrubbing hole 230H. The second cleaning solution 227 may flow over the first scrubbing wall 235 to the lower part of the scrubbing chamber 210.

The scrubbing apparatus 20 illustrated in FIG. 11 includes only one scrubbing plate 230. Therefore, the height of the scrubbing apparatus 20 in the second direction D2 may be reduced. That is, when using the scrubbing apparatus 20 according to some other embodiments of the present invention, space efficiency may be further improved.

Referring to FIG. 12, in some embodiments, the separating wall 220 may have an L-shaped structure in a planar view. For example, in a planar view, one portion of the separating wall 220 may extend in the third direction D3, and another portion may extend in the first direction D1. One end of the separating wall 220 may be connected to and in contact with the fourth inner side wall 210SW4 of the scrubbing chamber 210, and the other end of the separating wall 220 may be connected to and in contact with the second inner side wall 210SW2 of the scrubbing chamber 210. That is, as shown in FIG. 12, the separating wall 220 may have an L-shaped structure rotated clockwise in a planar view.

In some embodiments, the first sub-space 215a may also have an L-shaped structure in a planar view. Specifically, the first sub-space 215a may have an L-shaped structure rotated clockwise in a planar view. The first sub-space 215a may be defined, in a planar view, by the first inner side wall 210SW1 of the scrubbing chamber 210, the third inner side wall 210SW3 of the scrubbing chamber 210, and the separating wall 220. As the first sub-space 215a is formed with a relatively large area, a greater amount of first impurities may be dissolved into the first cleaning solution within the first sub-space 215a.

Referring to FIG. 13, in some embodiments, the separating wall 220 may have a U-shaped structure in a planar view. For example, in a planar view, one portion of the separating wall 220 may extend in the third direction D3, and other portions may extend in the first direction D1.

One end of the separating wall 220 may be connected to and in contact with the second inner side wall 210SW2 of the scrubbing chamber 210, and the other end may also be connected to and in contact with the second inner side wall 210SW2. That is, as shown in FIG. 13, the separating wall 220 may have a U-shaped structure rotated counterclockwise in a planar view.

In some embodiments, the first sub-space 215a may likewise have a U-shaped structure in a planar view. Specifically, the first sub-space 215a may have a U-shaped structure rotated counterclockwise in a planar view.

The first sub-space 215a may be defined by the first inner side wall 210SW1, the third inner side wall 210SW3, the fourth inner side wall 210SW4 of the scrubbing chamber 210, and the separating wall 220 in a planar view. As the first sub-space 215a is formed with a relatively large area, a greater amount of first impurities may be dissolved into the first cleaning solution within the first sub-space 215a.

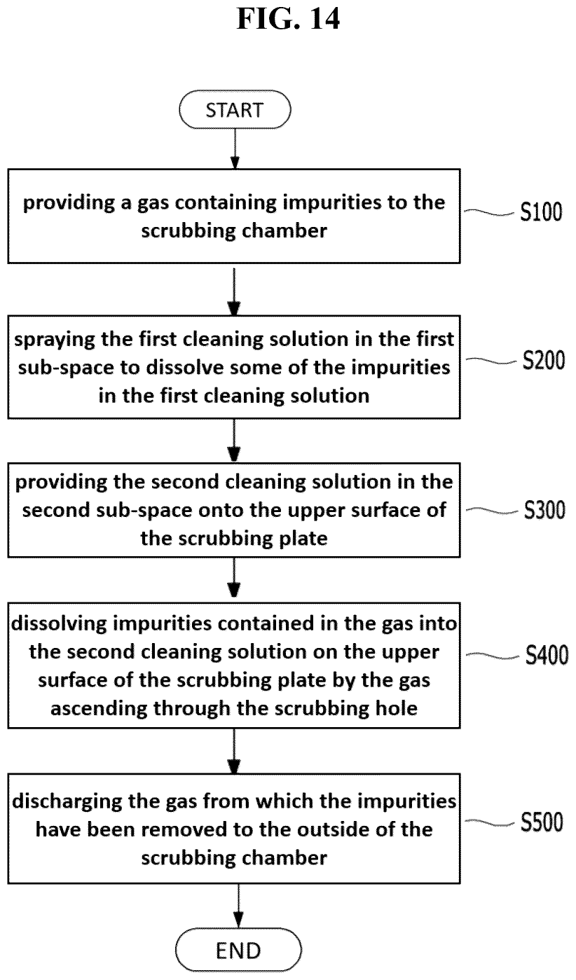

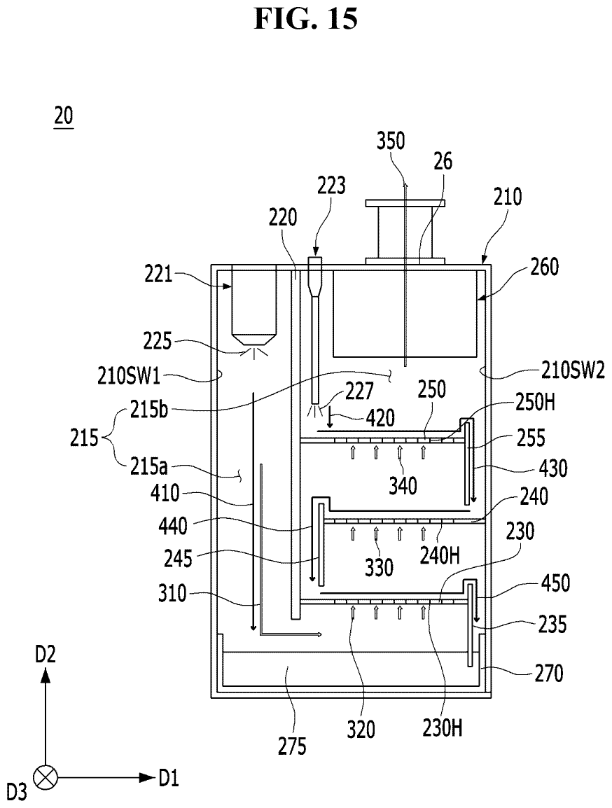

Hereinafter, an operating method of the scrubbing apparatus according to some embodiments of the present invention will be described with reference to FIGS. 14 and 15. For reference, FIG. 14 may be an exemplary flowchart for explaining an operating method of the scrubbing apparatus according to some embodiments of the present invention.

FIGS. 14 and 15 are drawings for explaining an operating method of a scrubbing apparatus according to some embodiments of the present invention.

First, referring to FIG. 14, an operating method of the scrubbing apparatus according to some embodiments of the present invention may include providing a gas containing impurities to the scrubbing chamber S100, spraying the first cleaning solution in the first sub-space to dissolve some of the impurities in the first cleaning solution S200, providing the second cleaning solution in the second sub-space onto the upper surface of the scrubbing plate S300, dissolving impurities contained in the gas into the second cleaning solution on the upper surface of the scrubbing plate by the gas ascending through the scrubbing hole S400, and discharging the gas from which the impurities have been removed to the outside of the scrubbing chamber S500. The concentration of the impurities contained in the gas discharged to the outside of the scrubbing chamber may be very low.

Specifically, referring to FIG. 1 and FIG. 15, the gas G containing impurities may be provided from the process chamber 10 to the scrubbing apparatus 20. The gas G containing impurities may pass through a first pipe 11 and be introduced into the interior of the scrubbing apparatus 20 through the gas inlet 25 (see reference numeral 310).

The gas G containing impurities may be introduced into the first sub-space 215a. For example, the gas G containing impurities may move to the lower part of the first sub-space 215a (see reference numeral 310).

In some embodiments, the first scrubbing process may be performed in the first sub-space 215a.

Specifically, the first cleaning solution 225 may be supplied to the first sub-space 215a through the spray nozzle 221 (see reference numeral 410). The first cleaning solution 225 may be water, but the technical scope of the present invention is not limited thereto. As another example, the first cleaning solution 225 may be a viscous substance.

In FIG. 15, the first cleaning solution 225 is depicted as being sprayed vertically in the second direction D2, but the technical scope of the present invention is not limited thereto. As illustrated in FIG. 7, the first cleaning solution 225 may be sprayed in the first direction D1. In addition, as illustrated in FIG. 8, the first cleaning solution 225 may be sprayed in any direction intersecting the first direction D1 and the second direction D2.

The spray nozzle 221 may supply the first cleaning solution 225 having fine particles. As gas G containing impurities moves into the lower part of the first sub-space 215a, impurities contained in the gas G may be dissolved into the first cleaning solution 225. The first scrubbing process may be a process in which impurities contained in the gas G are dissolved into the first cleaning solution 225.

The gas G, from which some impurities have been removed, may be supplied to the second sub-space 215b (see reference numeral 310). In the second sub-space 215b, the second scrubbing process may be performed. The second scrubbing process may be a process in which impurities contained in the gas G are dissolved into the second cleaning solution 227.

In some embodiments, the impurities scrubbed during the first scrubbing process and the impurities scrubbed during the second scrubbing process may be the same or different.

While the second scrubbing process is performed, the cleaning solution supply nozzle 223 may supply the second cleaning solution 227 onto the upper surface of the third scrubbing plate 250 (see reference numeral 420). The second cleaning solution 227 initially supplied may flow downward through the third scrubbing hole 250H, the second scrubbing hole 240H, and the first scrubbing hole 230H. That is, in an initial state, the second cleaning solution 227 may flow downward through the scrubbing holes 250H, 240H, and 230H.

While the second scrubbing process is being performed, the gas G may ascend in the second direction D2. The gas G may pass through the first scrubbing hole 230H and ascend in the second direction D2.

Specifically, referring to FIG. 4, the gas G may ascend through the first scrubbing hole 230H. As the gas G ascends in the second direction D2, bubbles BBL may be formed within the second cleaning solution 227. The impurities contained in the gas G may be dissolved into the second cleaning solution 227 at the contact area between the bubbles BBL and the second cleaning solution 227.

While the second scrubbing process is performed, the second cleaning solution 227 may not flow downward through the scrubbing holes 250H, 240H, and 230H. This may be due to the pressure of the gas G ascending through the scrubbing holes 250H, 240H, and 230H.

While the second scrubbing process is performed, the second cleaning solution 227 may flow from the upper surface of the third scrubbing plate 250 toward the third scrubbing wall 255 and may then overflow the third scrubbing wall 255 and flow onto the upper surface of the second scrubbing plate 240 (see reference numeral 430). The second cleaning solution 227 may then flow from the upper surface of the second scrubbing plate 240 toward the second scrubbing wall 245 and may overflow the second scrubbing wall 245 to flow onto the upper surface of the first scrubbing plate 230 (see reference numeral 440). Furthermore, the second cleaning solution 227 may flow from the upper surface of the first scrubbing plate 230 toward the first scrubbing wall 235 and may overflow the first scrubbing wall 235 to flow into the lower part of the scrubbing chamber 210 (see reference numeral 450).

The first cleaning solution 225 supplied into the first sub-space 215a may be stored in the cleaning solution storage tank 270 after the first scrubbing process is performed. The second cleaning solution 227, after overflowing the first scrubbing wall 235, may be stored in the cleaning solution storage tank 270 following the second scrubbing process. The cleaning solution in which impurities are dissolved 275 may be stored in the cleaning solution storage tank 270. The cleaning solution 275 in which impurities are dissolved may include both the first cleaning solution with dissolved impurities and the second cleaning solution with dissolved impurities.

While the second cleaning solution 227 flows in the above-described manner, the gas G may ascend through the scrubbing holes 250H, 240H, and 230H in the second direction D2. As the gas G passes through the scrubbing holes 250H, 240H, and 230H, the bubbles may be formed in the second cleaning solution 227.

Specifically, the gas G may ascend through the first scrubbing hole 230H (see reference numeral 320), then through the second scrubbing hole 240H (see reference numeral 330), and further through the third scrubbing hole 250H (see reference numeral 340).

While the gas G ascends through the scrubbing holes 250H, 240H, and 230H, impurities contained in the gas G may be dissolved into the second cleaning solution 227.

Thereafter, the gas G′, from which the impurities have been removed, may pass through the demister 260 and be discharged to the outside of the scrubbing chamber 210 (see reference numeral 350). The gas G′ discharged through the gas outlet 26 may contain almost no remaining impurities.

Although the embodiments of the present invention have been described with reference to the attached drawings, the present invention is not limited to the embodiments described above, but can be manufactured in various different forms, and a person having ordinary skill in the art to which the present invention pertains will understand that the present invention can be implemented in other specific forms without changing the technical scope or essential features of the present invention. Therefore, it should be understood that the embodiments described above are exemplary in all respects and not restrictive.

1. A scrubbing apparatus comprising:
a scrubbing chamber defining a scrubbing space for scrubbing impurities contained in a gas;
a separating wall dividing the scrubbing space into a first sub-space and a second sub-space;
a spray nozzle disposed in the first sub-space, and spraying a first cleaning solution into the first sub-space;
a scrubbing plate disposed in the second sub-space, and fixed to the separating wall;
a cleaning solution supply nozzle disposed in an upper part of the second sub-space, and supplying a second cleaning solution to an upper surface of the first scrubbing plate;
a cleaning solution storage tank installed in a lower part of the scrubbing chamber, and storing the first cleaning solution with the impurities dissolved therein and the second solution with the impurities therein; and
a plurality of first scrubbing hole penetrating the first scrubbing plate,
wherein a portion of the impurities contained in the gas is dissolved in the first cleaning solution in the first sub-space, and
wherein another portion of the impurities contained in the gas is dissolved in the second cleaning solution on the upper surface of the first scrubbing plate after the gas ascends through the plurality of first scrubbing holes in the second sub-space.

2. The scrubbing apparatus of claim 1, wherein the dissolving another portion of the impurities contained in the gas into the second cleaning solution comprises the forming bubbles within the second cleaning solution on the upper surface of the first scrubbing plate as the gas ascends through the plurality of first scrubbing holes, and dissolving the impurities at the contact area between the bubbles and the second cleaning solution.

3. The scrubbing apparatus of claim 1, wherein a first impurity dissolved in the first cleaning solution in the first sub-space and a second impurity dissolved in the second cleaning solution in the second sub-space are different from each other, and
wherein the first cleaning solution is different from the second cleaning solution.

4. The scrubbing apparatus of claim 3, wherein the first cleaning solution is viscosity, and the second cleaning solution is non-viscous.

5. The scrubbing apparatus of claim 3, wherein a particle size of the first impurity dissolved in the first cleaning solution is different from a particle size of the second impurity dissolved in the second cleaning solution.

6. The scrubbing apparatus of claim 1, further comprising:
a second scrubbing plate disposed in the second sub-space, and disposed on a lower surface opposing the upper surface of the first scrubbing plate; and
a plurality of second scrubbing holes penetrating the second scrubbing plate,
wherein the first scrubbing plate and the second scrubbing plate are arranged in a zigzag configuration.

7. The scrubbing apparatus of claim 6, wherein the second cleaning solution flows in a first direction along the upper surface of the first scrubbing plate and is discharged onto an upper surface of the second scrubbing plate,
wherein the second cleaning solution flows in a negative first direction along the upper surface of the second scrubbing plate, and
wherein the lower surface of the first scrubbing plate and the upper surface of the second scrubbing plate face each other.

8. The scrubbing apparatus of claim 6, further comprising:
a third scrubbing plate disposed in the second sub-space, fixed to the separating wall, and disposed on a lower surface opposing the upper surface of the second scrubbing plate; and
a plurality of third scrubbing holes penetrating the third scrubbing plate,
wherein the second scrubbing plate and the third scrubbing plate are arranged in a zigzag configuration, and
wherein the first scrubbing plate and the third scrubbing plate overlap each other in a vertical direction.

9. The scrubbing apparatus of claim 1, further comprising:
a second scrubbing plate disposed in the second sub-space, and disposed on a lower surface opposing the upper surface of the first scrubbing plate; and
a plurality of second scrubbing holes penetrating the second scrubbing plate,
wherein a shape of the first scrubbing plate is different from a shape of the second scrubbing plate,
wherein the first scrubbing plate includes an opening exposing at least a portion of the upper surface of the second scrubbing plate, and
wherein the second scrubbing plate is spaced apart from the separating wall.

10. The scrubbing apparatus of claim 9, wherein the second cleaning solution flows along the upper surface of the first scrubbing plate toward the opening and is discharged onto the upper surface of the second scrubbing plate,
wherein the second cleaning solution flows along the upper surface of the second scrubbing plate in a direction opposite to the opening, and
wherein the lower surface of the first scrubbing plate and the upper surface of the second scrubbing plate face each other.

11. The scrubbing apparatus of claim 1, wherein the separating wall has at least one of a bar shape, an L-shape, or a U-shape in a planar view.

12. The scrubbing apparatus of claim 1, wherein the cleaning solution storage tank includes a first tank and a second tank that are separated from each other,
wherein the first tank stores the first cleaning solution with the impurities dissolved therein, and
wherein the second tank stores the second cleaning solution with the impurities dissolved therein.

13. The scrubbing apparatus of claim 1, wherein the spray nozzle sprays the first cleaning solution in a first direction, and
wherein the first direction is parallel to an extension direction of the first scrubbing plate.

14. The scrubbing apparatus of claim 1, wherein the spray nozzle sprays the first cleaning solution in a first direction, and
wherein the first direction intersects with both an extension direction of the first scrubbing plate and an extension direction of the separating wall.
